(19) United States
(12) Patent Application Publication
(10) Pub. No.: US 2012/0027195 A1
(43) Pub. Date: Feb. 2, 2012

(54) Automatic Editing out of Sensitive Information in Multimedia Prior to Monitoring and/or Storage

(75) Inventors: Shmuel Shaffer, Palo Alto, CA (US); Jochen Weppner, Belmont, CA (US); Shantanu Sarkar, San Jose, CA (US); Mukul Jain, San Jose, CA (US)

(73) Assignee: CISCO TECHNOLOGY, INC., San Jose, CA (US)

(21) Appl. No.: 12/846,316

(22) Filed: Jul. 29, 2010

(51) Int. Cl. H04M 3/00

(52) U.S. Cl. 379/265.09

(57) ABSTRACT

Techniques are provided to automatically edit multimedia associated with call center sessions when producing monitoring and/or recording copies of the multimedia. Multimedia associated with a session between a caller and a call center agent is received. The multimedia from the session is analyzed to determine when sensitive information is to be revealed. The multimedia is edited to mask the sensitive information in a monitored and/or recorded copy of the multimedia.

### TECHNICAL FIELD

The present disclosure relates to techniques for recording and/or monitoring multimedia associated with a call center session.

### BACKGROUND

When recording multimedia associated with certain activities, such as call center sessions between a call center agent and a caller, sensitive information may be revealed by the caller to the call center agent. For example, the call center agent may enter that information into a digital form that is then used to retrieve other information to assist the caller. One example is when a caller calls a bank to obtain information about his/her bank account.

In order to track customer service quality, many of these calls and their associated data entry activities are monitored and/or recorded. The recorded or monitored multimedia thus will contain sensitive information of the caller revealed during the session. In many cases this is undesired as it may be against company policies or the law in a given jurisdiction to record certain personal information. In addition, sensitive information of a person is kept in the recorded data and unauthorized access to that data could occur, resulting in possible identity theft of the person whose sensitive information is contained in the recorded data.

### BRIEF DESCRIPTION OF THE DRAWINGS

FIG. 1 is an example of a block diagram of a system in which multimedia from a call center session that is to be monitored and/or recorded is automatically processed to edit out or mask sensitive information.

FIG. 2 is an example of a block diagram of a recording server configured to perform a monitoring and recording editing process to automatically edit out or mask sensitive information in the multimedia for a call center session.

FIG. 3 is an example of a flow chart for monitoring and recording editing process at the recording server.

FIG. 4 is an example of a diagram depicting a form in which data is entered and certain data is to be automatically edited out or masked prior to storage and/or monitoring.

FIG. 5 is an example of a timing diagram for an audio stream and showing the editing out or masking of a portion of the audio stream containing sensitive information.

FIG. 6 is an example of a diagram of a document in which the presence of certain words is detected to edit out portions of the document in the monitoring and/or recording copy of the session.

FIG. 7 is an example of a diagram depicting the form of FIG. 4 with a portion of the form containing sensitive information edited out or masked prior to storage and/or monitoring.

FIG. 8 is a diagram depicting an example of relationships between one field in a form and other fields in related forms that are to be treated as sensitive information.

FIG. 9 is an example of a diagram of a form showing fields that are to be edited out and other fields that are not to be edited out based on the relationships depicted in FIG. 8.

### DESCRIPTION OF EXAMPLE EMBODIMENTS

Overview

Techniques are provided herein to automatically edit multimedia associated with call center sessions when monitoring and/or recording the multimedia. Multimedia associated with a session between a caller and a call center agent is received. The multimedia for the session is analyzed to determine when sensitive information is about to be revealed. The multimedia is edited to mask the sensitive information in a monitored and/or recorded copy of the multimedia.

### Example Embodiments

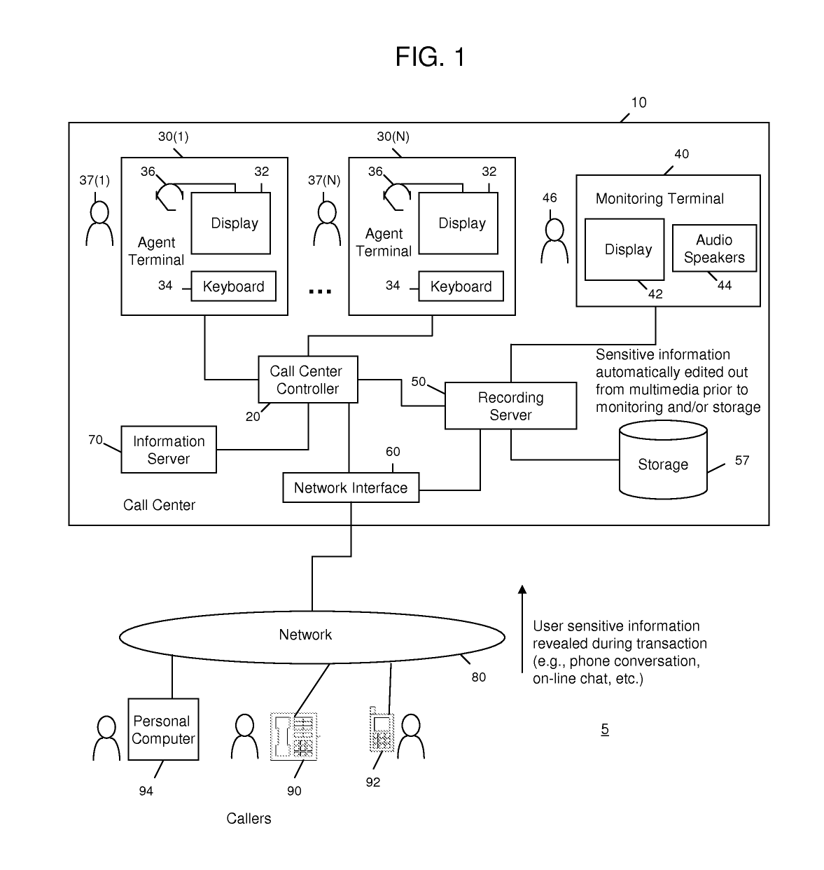

Referring first to FIG. 1, a diagram is shown of a system 5 in which a call center 10 communicates in various forms with callers to provide various services for the callers. The call center 10 comprises a call center controller 20, agent terminals 30(1)-30(N), a monitoring terminal 40, a recording server 50, a data storage unit 57, a network interface device or unit 60 and an information server 70. The call center controller 20 is the main controller for the call center and handles interactions with call center agents, and activating monitoring of a session to a monitoring terminal 40 and other functions.

The agent terminals 30(1)-30(N) comprise a display monitor 32, a keyboard 34 and a headset 36 with an audio microphone and speakers. The agent terminals 30(1)-30(N) may be terminal devices or they may be personal computer devices. The monitoring terminal 40 comprises a display monitor 42 and audio speakers 44. In one example, the monitoring terminal 40 may be a personal computer. Call center agents associated with the agent terminals are shown at reference numerals 37(1)-37(N) and a monitoring person associated with the monitoring terminal 40 is shown at 46.

The recording server 50 is configured to automatically edit out portions of the multimedia that are determined to contain sensitive information. This editing function may be invoked by the call center controller 20. The recording server 50 sends the edited monitoring copy of the multimedia to the monitoring terminal 40 and sends the edited recording copy of the multimedia to the data storage 57 for storage. The network interface device 60 enables communication to and from the call center 10 via a network 80.

The information server 70 is a computer server that responds to requests for data from a call center agent during a session with a caller. The information server 70 retrieves data and generates forms that are displayed to the call center agent for use during a session. The information server 70 also receives information entered by the call center agent into a form in order to retrieve additional information for the call center agent to use during a session with a caller. The information server 70 is shown as being part of the call center 10 but this is only an example. It is also possible that the information server 70 is separate from the call center 10 and connected to network 80 to enable remote access by the call center agent terminals 30(1)-30(N), via the call center controller 20.

Callers interact with the call center via the network 80. For example, a caller may use a landline telephone 90, a mobile phone 92 or a personal computer 94 to communicate with the call center 10. The network 80 consists of a collection of voice and data (wired and wireless) networks through which the devices 90-94 interface and also to which the call center 10 interfaces via the network interface 60.

A session between a caller and a call center agent may consist of a voice call and the call center agent retrieves information at the request of the caller, which information is displayed to the call center agent on his/her display monitor. The call center agent can then read from the displayed information and speak it back to the caller as needed, and perform other functions for caller. In another mode, the session may comprise an on-line chat session whereby the caller and call center agent exchange short statements in an on-line chat or instant messaging format, and the call center agent retrieves information for the caller by copying text sent by the caller to the call center agent and pasting that information into various forms that are displayed to the call center agent on a display monitor. In another variation, the caller may enter the sensitive information himself/herself to a form that is displayed simultaneously to the caller and the call center agent. In still another example, the session may be a text message exchange between the caller and the call center agent, and the call center agent retrieves information for the caller in a manner similar to that described for an on-line chat or instant messaging session. In the on-line chat and text messaging examples, the exchanges between the caller and call center agent are maintained in video that tracks the displayed exchanges to the call center agent. In still another mode, the caller and call center agent may be engaged in a live video session that also includes any of the types of multimedia described herein.

Thus, the term “caller” is not meant to be limited to a person who makes a voice call and it may apply to on-line exchanges, text-based exchanges, a video session or any combination of multimedia interactions described above. Likewise, the term “call center” is not meant to be limited to a standard call center in this regard. Moreover, the call center may be used for customer support, account information such as with a bank or investment entity, or any other call or contact center in which people seek information and a center is established to receive the calls or communications from callers to respond to questions or receive information from people.

A session between a caller and a call center agent may involve interaction by the call center agent with displayed forms, such as data entry into a displayed form based on information supplied by the caller, data retrieval, etc. The call center controller 20 generates the information that is displayed on a display 32 of an agent terminal to a call center agent. When a monitoring function of a session between a call center agent and a caller is activated, such as by a supervisor, the call center controller 20 renders the same multimedia that is presented to the agent terminal, after the recording server 50 has edited it as described herein, to the monitoring terminal 40. Similarly, when a recording functionality is requested for a session between a call center agent and a caller, the same multimedia, after the recording server 50 has edited it, is sent to the data storage 57 for storage. In addition, the call center controller 20 captures any audio for voice conversations between the call center agent and a caller and sends it to the recording server 50 for editing when a monitoring and/or recording function is activated. In a Voice over Internet Protocol (VoIP) implementation of a call center system, voice/media and control/signaling do not necessarily travel in the same path. The multimedia associated with a call agent session travels in a path directly between the two endpoints involved in the session. The call center controller 20 handles the signaling/control signals and the multimedia is directed to the recording server 50 for automatic editing when a monitoring and/or recording function is activated. In a VoIP system implementation, the call center controller 20, agent terminals 30(1)-30(N), monitoring terminal 40 and recording server 50 all have network connectivity to each other. The monitoring terminal 40 is used, for example, by a call agent supervisor to monitor sessions handled by call center agents, and/or for a person undergoing training to become a call center agent in order to view activities of a call center agent as part of a training program.

The term “multimedia” as used herein is meant to refer to one or more of text, audio, still images, animation, video, metadata and interactivity content forms associated with a session between a caller and a call center agent.

During a session between a call center agent and a caller for certain types of transactions (e.g., bank account transactions, investment account transactions, medical information transactions, etc.) sensitive information of the caller may be revealed (either by the caller or the call center agent) in the multimedia associated with the session. The sensitive information may be revealed in audio, video and/or other data. The recording server 50 performs a “digital whiteout” or masking of a portion of multimedia frames containing sensitive information, a portion of audio containing sensitive information, or of data in a file that contains sensitive information. The recording server 50 automatically recognizes certain key phrases or other “signatures” that are associated with sensitive information that is revealed in the multimedia and edits the multimedia to block out or mask the sensitive information from a monitoring copy and/or recorded copy of the multimedia. Examples of sensitive information include personal data, e.g., Social Security Number or other person identification number, bank account number, personal identification codes, etc. The sensitive information may be revealed when it is entered by a call center agent into a field of a form displayed to the call center agent. The sensitive information may reside in a portion of a video frame associated with the display of the digital form that the call center agent is working with or in a confidential document. In addition, the sensitive information may be contained in a portion of an audio stream in which the confidential or sensitive information is spoken.

Thus, in one example, the multimedia comprises audio associated with a conversation between the caller and the call center agent and data associated with interaction by the call center agent with a form displayed on a monitor to the call center agent.

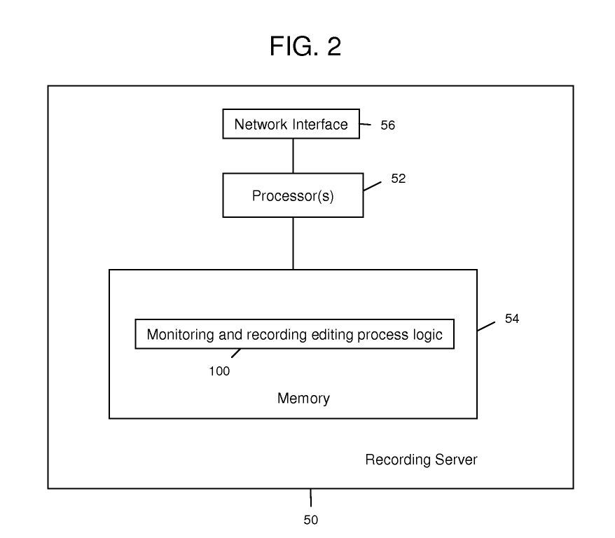

Reference is now made to FIG. 2 for a description of an example of a block diagram of the recording server 50. The recording server 50 comprises one or more processors 52 and memory 54. In addition, in the case where the recording server capabilities for monitoring and recording of call center sessions is located remote (across the network 80, e.g., in a remote location connected via a wide area network) from the call center agents, then the recording server 50 also comprises a network interface device or unit 56 that is configured to receive the multimedia for sessions. The network interface device 56 may be useful even when the recording server monitoring and recording capabilities are local to the agent terminals.

The memory 54 is, for example, random access memory (RAM), but may comprise electronically erasable programmable read only memory (EEPROM) or other computer readable memory in which computer software may be stored or encoded for execution by the processor 52. At least some portion of the memory 54 is also writable to allow for storage of data generated during the course of the operations described herein. The processor 52 is configured to execute instructions stored in the memory 54 for carrying out the various techniques described herein. In particular, the processor 52 is configured to execute program logic instructions (i.e., software) stored in memory 54 for monitoring and recording editing process logic 100. Generally, the monitoring and recording editing process logic 100 is configured to cause the processor 52 to receive multimedia associated with a session between a caller and a call center agent, analyze the multimedia from the session to determine when sensitive information is about to be revealed and editing the multimedia to mask or hide the sensitive information in a monitored and/or recorded copy of the multimedia stream.

The operations of processor 52 may be implemented by logic encoded in one or more tangible media (e.g., embedded logic such as an application specific integrated circuit, digital signal processor instructions, software that is executed by a processor, etc), wherein memory 54 stores data used for the operations described herein and stores software or processor executable instructions that are executed to carry out the operations described herein. The monitoring and recording editing process logic 100 may take any of a variety of forms, so as to be encoded in one or more tangible media for execution, such as fixed logic or programmable logic (e.g. software/computer instructions executed by a processor) and the processor 52 may be an application specific integrated circuit (ASIC) that comprises fixed digital logic, or a combination thereof. For example, the processor 52 may be embodied by digital logic gates in a fixed or programmable digital logic integrated circuit, which digital logic gates are configured to perform the operations of the process logic 100. In one example, the process logic 100 is embodied in a tangible processor or computer-readable (non-transitory) memory medium (memory 54) that is encoded with instructions for execution by a processor (e.g. a processor 52) that, when executed by the processor, are operable to cause the processor to perform the operations described herein in connection with process logic 100. Memory 54 may also buffer multimedia (voice, video, data, text, etc.) streams associated with a caller-call center agent session.

The operations described herein to automatically edit multimedia associated with a caller-call agent session may be implemented in any suitable computing apparatus that is part of or separate from the call center 10 and which communicates with the call center 10 by the network 80.

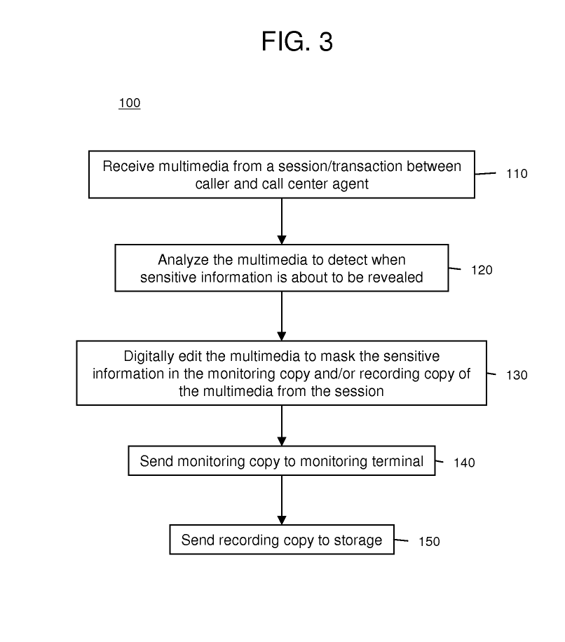

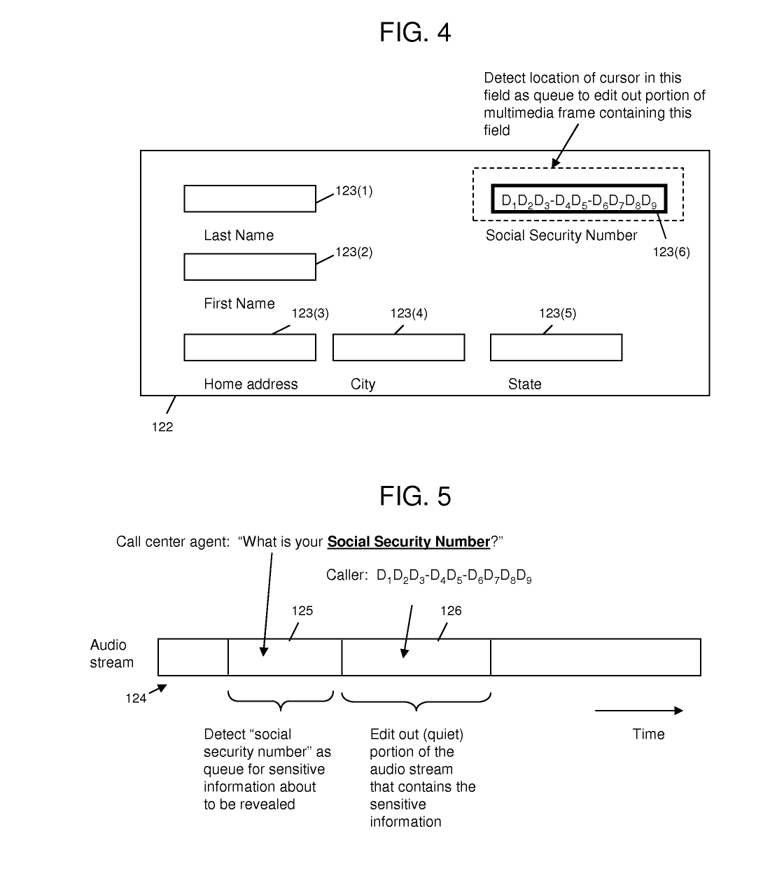

Reference is now made to FIG. 3 together with FIGS. 4-9 for a description of operations of the monitoring and recording editing process logic 100. At 110, multimedia from a session between a caller and a call center agent (at an agent terminal) is received or captured. The multimedia associated with the session may include audio, video, text, data, etc., as described above. At 120, the multimedia is analyzed to detect when sensitive information is about to be revealed. The decision as to what is considered sensitive information and thus to be edited out versus what is not to be edited out in the recording copy and/or monitoring copy may be configurable in advance based on policy information as described herein. This can be performed at any point between the capture point and the storage point, including at the various endpoints or prior to storage.

Reference is now made to FIG. 4 to illustrate one example of the analysis performed at 120. In this example, a digital form is shown at 122 comprising fields 123(1)-123(6). This form is displayed on a display monitor 32 at one of the agent terminals 32(1)-32(N). There may be additional fields in the form containing additional information but they are omitted for purposes of this description. Field 123(6) is a field for a Social Security Number and this field will contain confidential information when it is filled in by the call center agent in response to the caller speaking the numbers to the call center agent, for example. In another situation, the form may be returned by the information server 70 to the display 32 of the call center agent with the Social Security Number field 123(6) already filled in for the call center agent so that the call center agent can verify a caller's identity before proceeding further in a transaction for the caller.

The processor 52 analyzes the text, video or graphical data associated with the digital form 122 to determine whether there is sensitive information about to be revealed. For example, the processor 52 can determine when the call center agent's point of focus, e.g., cursor, is at a portion of the multimedia such as form 122, e.g., a field such as field 123(6) that is designated to contain sensitive information in the form 122. Field 123(6) is an example of a portion of the form 122 where sensitive information is to be entered by the call center agent, or even by a caller in the case of an on-line chat session or text session, for example. Digits of a Social Security Number are shown as D₁D₂D₃-D₄D₅-D₆D₇D₈D₉. When the processor 52 detects the location of the cursor at field 123(6), it uses this as a queue to edit out or mask the portion of the multimedia that contain this field in the multimedia for the recording of the multimedia because it indicates that the call center agent is about to enter a caller's Social Security Number into that field. The location of the cursor at field 123(6) is indicated by the bold outline of the field 123(6) shown in FIG. 4. In another example, the processor 52 may analyze the text of the titles of each of the fields of the form to detect any fields that are determined to be designated for sensitive information, such as Social Security Number, Account Balance, etc. When the processor 52 recognizes that there is a field with a title for sensitive information, it automatically flags that field to be edited out before storing the associated multimedia and/or sending the multimedia to the monitoring terminal 40.

Reference is now made to FIG. 5. FIG. 5 shows a timeline for an audio stream 124 associated with a caller-call center agent session. At some point in time during a conversation between the call center agent and the caller, the caller center agent may ask the caller for his/her Social Security Number. For example, the call center agent may ask “What is your Social Security Number?” during time interval 125. The processor 52 performs voice analytics of the audio stream to detect certain key words or phrases like “Social Security Number” (indicated by bold and underline in FIG. 5) that indicate an imminent response or revelation (in the audio stream for the conversation) that will contain sensitive information. Then, for a certain time period after detecting a key word or phrase, the processor 52 edits out (masks) the portion of the audio stream that contains the sensitive information. For example, the processor 52 imposes a quiet or blank interval for a time interval shown at 126 following time interval 125 when the key word or phrase was detected. The processor 52 may set the length of the time interval to be sufficient to allow a user to completely speak the sensitive information expected in response to the key word or phrase detected at 125. The editing out operation for time interval 125 is described hereinafter. In another example embodiment, the processor 52 uses speech recognition to identify numbers uttered after the question of time segment 125 and obfuscates them from the recording process.

In a call center session that is text-based or an on-line chat session, the processor 52 also detects certain key words in any of the words or phrases typed by the caller or call center agent during the session, and using these key words as a queue that sensitive information is about to be revealed during the session.

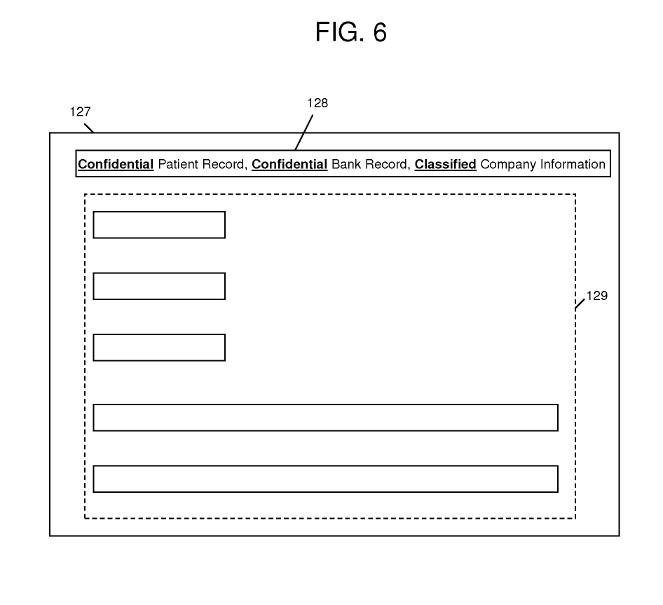

Turning to FIG. 6, still another example is shown of detecting that sensitive information is being revealed during a caller-call center agent session. FIG. 6 illustrates a document 127 that is retrieved for display to the call center agent during a session. The processor 52 is configured to detect presence of certain key words or phrases in a label or title of the document that suggests that there is sensitive information in the document. For example, the presence of the word “Confidential” or “Classified” in the document label 128 is detected as a queue or trigger that there is sensitive information in this document. These words are underlined and bolded in FIG. 6 to illustrate that they are types of words to be detected as indicators of sensitive information in the document. The body of the document that contains the sensitive information is shown at 129.

Reference is now made back to FIG. 3. At 130, the processor 52 digitally edits the multimedia to mask the sensitive information in the monitoring copy and/or recording copy of the multimedia from the session. As a result, the monitoring copy and/or recording copy of the multimedia for the session will not contain the sensitive information. Since the recording copy will not contain the sensitive information, the chance of unauthorized access to a person's confidential information by obtaining access to the recording data is greatly reduced. Moreover, since the monitoring copy will not contain the sensitive information, the one or more persons at the monitoring terminal will not be privy to any of the confidential information revealed during the session, whether for training or quality assurance monitoring purposes. However, the multimedia that the call center agent sees and hears during the session will contain the sensitive information so that the call center agent can perform his/her functions for the caller during the session. At 140, the monitoring copy (with the sensitive information masked or edited out) is sent to the monitoring terminal 40. At 150, the recording copy (with the sensitive information masked or edited out) is sent to the data storage 57.

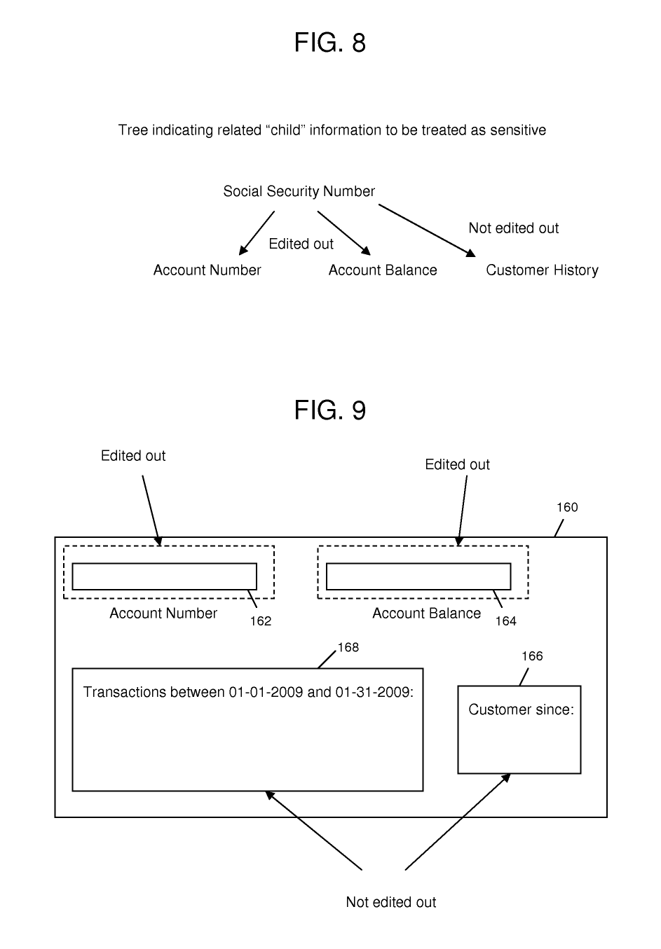

Policy information may be stored that indicates types of information to be edited out and/or queues or triggers for information to be edited out. The analyzing and editing operations 120 and 130 are performed based on the policy information. For example, in the case of fields in a form that are displayed to a call center agent, policy information may be stored that indicates which fields of forms are to be masked and the editing operation at 130 is performed to mask one or more portions of video frames in the video based on the policy information. In addition, the policy information may include information indicating relationships between fields in different, but related forms, and whether fields in other forms should be masked as well. Examples of the policy information for fields in forms are described in more detail hereinafter in connection with FIGS. 8 and 9. In the case of audio or video, policy information may also be stored to indicate one or more key words or phrases (detected by audio analytics of the audio) that are trigger indicators of imminent audio that will contain sensitive information to be masked in the audio.

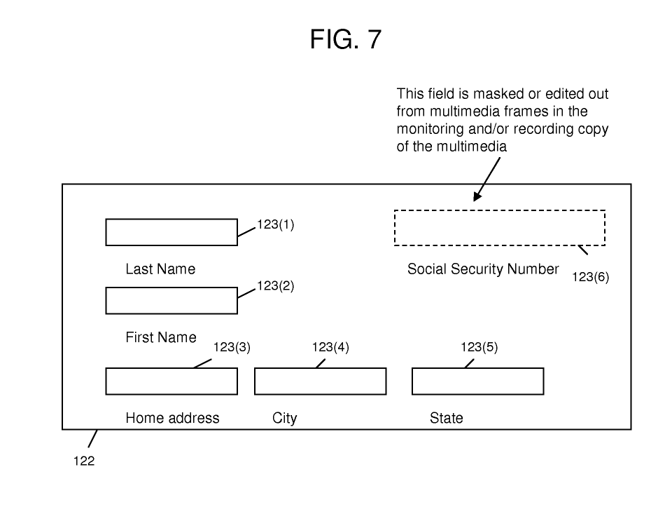

Examples of techniques to edit the sensitive information are now described. FIG. 6 shows a video screen shot of a frame of a video signal in the recording copy and/or monitoring copy of a session in which the digital form shown in FIG. 4 was edited to mask or edit out the sensitive information. As shown in FIG. 6, the area of the video frame for the field 123(6) containing a Social Security Number is masked or digitally edited out so that the Social Security Number digits in that field of the form are not visible. The editing process depicted in FIG. 7 is also referred to herein as a digital “white out” where a portion of the video frame containing the sensitive information is digitally edited to hide or mask that information at the pixel locations of video frames where that information would otherwise be visible.

Another example is shown in FIG. 5 for the audio portion of a session. As mentioned above in connection with FIG. 5, the time interval 126 of the audio that is predicted from the queue detected at 125 to contain sensitive information (or is detected by identifying digits related to the confidential social security number 123(6)) is edited out by quieting (reducing the audio signal level to 0) so that there is no audio during that portion of the recording and/or monitoring copy of the audio.

Still another example is shown in FIG. 6 where the entire body of a document is digitally edited out or masked in the recording and/or monitoring copy. For example, all of the information contained within area 129 of the document is digitally edited out or masked in the video frames of the video for the recording copy and/or monitoring copy of the session, or in any saved or stored document associated with monitoring or recording copy of the session.

Reference is now made to FIGS. 8 and 9 for further examples of portions of a digital form to be edited out. FIG. 8 shows a relationship tree between fields of one or more related digital forms. At the top of the tree is the Social Security Number field. There are several fields that are related to the Social Security Number field: Account Number field, Account Balance field and Customer History field. The Account Number field, Account Balance field and Customer History fields are “child” fields with respect to the Social Security Number field. Policy information may be stored in the call center controller to define which fields are designated as containing sensitive information that should be masked in the recording and/or monitoring copies, as well as which “child” fields for a given field are also deemed to contain sensitive information and thus should be masked in the recording and/or monitoring copies.

FIG. 9 illustrates an example of a monitoring and/or recording copy of a video frame for a form 160 containing child fields 162, 164 and 166 from the example of FIG. 8 and another unrelated field 168. The fields 162 and 164 are edited out and field 166 is not edited out per the policy information depicted in FIG. 8 described above. Likewise, field 168, which is not related to the Social Security Number field in the policy information, is also not edited out. Thus the policy information stored at the call center controller may indicate a relationship between at least one field that is to be masked in a first form displayed to the call center agent and one or more other fields that are also to be masked in a second form displayed to the call center agent.

The techniques described herein prevent undesirable disclosure of personal or sensitive information when a recording of session is made. Callers and operators of call centers have a greater sense of confidence to know that confidential information or other sensitive information is not included in the recorded or monitored data.

The above description is intended by way of example only.

What is claimed is:

1. A method comprising:
receiving multimedia associated with a session between a caller and a call center agent;
analyzing the multimedia from the session to determine when sensitive information is about to be revealed; and
editing the multimedia to mask the sensitive information in a monitoring and/or recording copy of the multimedia.

2. The method of claim 1, wherein receiving comprises receiving the multimedia including audio associated with a conversation between the caller and the call center agent and data associated with interaction by the call center agent with a form displayed on a display to the call center agent.

3. The method of claim 2, wherein analyzing comprises analyzing the audio to detect words that indicate sensitive information is about to be revealed in the audio.

4. The method of claim 3, wherein editing comprises masking a portion of the audio that contains the sensitive information.

5. The method of claim 2, wherein analyzing comprises analyzing the multimedia to detect that the call center agent's focus is in a portion of the form where sensitive information is to be entered.

6. The method of claim 5, wherein analyzing comprises analyzing the multimedia to detect a position of a cursor in a field of the form that is to contain sensitive information.

7. The method of claim 5, wherein editing comprises masking a portion of multimedia frames in the multimedia that contains the sensitive information.

8. The method of claim 2, and further comprising storing policy information indicating types of information to be masked in the multimedia and/or queues for sensitive information to be masked in the multimedia, and wherein analyzing and editing are performed based on the policy information.

9. The method of claim 8, wherein storing policy information comprises storing information indicating which fields of forms during the session are to be masked.

10. The method of claim 9, wherein storing policy information comprises storing information indicating a relationship between at least one field that is to be masked in a first form displayed to the call center agent and one or more other fields that are also to be masked in a second form displayed to the call center agent.

11. The method of claim 2, wherein storing policy information comprises storing information indicating one or more words or phrases to be detected as trigger indicators of imminent audio that will contain sensitive information to be masked in the audio.

12. A computer-readable memory medium storing instructions that, when executed by a processor, cause the processor to:
receive multimedia associated with a session between a caller and a call center agent;
analyze the multimedia from the session to determine when sensitive information is about to be revealed; and
edit the multimedia to mask the sensitive information in a monitoring and/or recording copy of the multimedia.

13. The computer-readable memory medium of claim 12, wherein the instructions that cause the processor to receive comprise instructions that cause the processor to receive multimedia including audio associated with a conversation between the caller and the call center agent and data associated with interaction by the call center agent with a form displayed on a display to the call center agent.

14. The computer-readable memory medium of claim 13, wherein the instructions that cause the processor to analyze comprise instructions that cause the processor to analyze the multimedia to detect words that indicate sensitive information is about to be revealed in the audio.

15. The computer-readable memory medium of claim 14, wherein the instructions that cause the processor to edit comprise instructions that cause the processor to mask a portion of the multimedia that contains the sensitive information.

16. The computer-readable memory medium of claim 13, wherein the instructions that cause the processor to analyze comprise instructions that cause the processor to analyze the multimedia to detect that the call center agent's focus is in a portion of the form where sensitive information is to be entered.

17. The computer-readable memory medium of claim 16, wherein the instructions that cause the processor to analyze comprise instructions that cause the processor to detect a position of a cursor in a field of the form that is to contained sensitive information.

18. The computer-readable memory medium of claim 16, wherein the instructions that cause the processor to edit comprise instructions that cause the processor to mask a portion of multimedia frames in the multimedia that contains the sensitive information.

19. An apparatus comprising:
a network interface unit configured to receive multimedia associated with a session between a caller and call center agent;
a processor configured to be coupled to the network interface unit, wherein the processor is configured to:
analyze the multimedia from the session to determine when sensitive information is about to be revealed; and
edit the multimedia to mask the sensitive information in a monitoring and/or recording copy of the multimedia.

20. The apparatus of claim 19, wherein the network interface unit is configured to receive multimedia comprising multimedia associated with a conversation between the caller and the call center agent and data associated with interaction by the call center agent with a form displayed on a display to the call center agent.

21. The apparatus of claim 20, wherein the processor is configured to analyze the multimedia to detect words that indicate sensitive information is about to be revealed in the multimedia, and the processor is configured to edit the multimedia by masking a portion of the multimedia that contains the sensitive information.

22. The apparatus of claim 20, wherein the processor is configured to analyze the multimedia to detect that the call center agent's focus is in a portion of the form where sensitive information is to be entered, and the processor is configured to edit the multimedia by masking a portion of video frames in the multimedia that contains the sensitive information.

23. The apparatus of claim 19, wherein the processor is further configured to store policy information indicating types of information to be masked in the multimedia and/or queues for sensitive information to be masked in the multimedia, and wherein the processor is configured to analyze and edit based on the policy information.
